(19) United States
(12) Patent Application Publication
(10) Pub. No.: US 2005/0065905 A1
(43) Pub. Date: Mar. 24, 2005

(54) Security management system for a computer, and methods of constructing and utilizing the same

(75) Inventors: Jiessie Zhang, Chongqing (CN); Ares Li, Chongqing (CN)

Correspondence Address: HOGAN & HARTSON L.L.P., 500 S. GRAND AVENUE, SUITE 1900, LOS ANGELES, CA, 90071-2611, US

(73) Assignee: FarStone Tech. Inc.

(21) Appl. No.: 10/913,789

(22) Filed: Aug. 6, 2004

(30) Foreign Application Priority Data
Aug. 6, 2003 (TW) 92121450

(51) Int. Cl. G06F 7/00

(52) U.S. Cl. 707/1

(57) ABSTRACT

A computer system having a file system that cannot be directly recognized by an operating system (OS). In the computer system of the invention, the file system is emulated, and cannot be directly recognized. Therefore, the computer system is secure and maintainable.

### BACKGROUND OF THE INVENTION

1. Field of Invention

The present invention relates to a security protection technique for a computer system. More particularly, the present invention relates to a backup/recovery system and methodology, protects the computer system and data thoroughly.

2. Description of Related Art

Conventional backup/recovery software establishes recovery points to backup data by using a static backup technique for storing data over a long period of time. When the data is in a state of maintenance, all valid data of such data in maintenance will be backed up. Accordingly to the conventional backup/recovery software, backing up data by this static backup technique takes up fixed storage space in the computer system. Moreover, the backed-up data is kept in a state of perpetuity, independent of other current or future data contained in a data storage means, such as a hard disk, of the computer system.

For example, the conventional backup/recovery software, such as the Ghost software developed by Symantec Corporation, includes a backup program to back up all data stored in selected partitions of the hard disk to a file. In addition, it further includes a recovery program for restoring the data from the file to the selected partitions of the hard disk. Prior to backing up the data, the Ghost software stops all other tasks in the computer. It then creates the backup file, with all the backed-up data, in a single task procedure. Generally, this backup procedure takes about 8 minutes per Gigabyte.

Since the Ghost software backs up all the valid data stored in the hard disk, the data itself backed up by the Ghost software occupies an extremely large space in the hard disk. In addition, all data currently used by the file system of the operating system (OS) will be backed up into the backup file. This occurs no matter whether such related data would be further changed in the future or not, thereby further occupying a great amount of space in the hard disk.

Some presently available backup/recovery software, such as the Goback software developed by Adaptec Corporation and the Pro Magic software developed by WASAY Incorporation, adopt a dynamic backup technique in establishing recovery points during the data backup process. Such dynamic backup technique restores the computer system to a previous state, in accordance with the previous backup data, from a current state. The valid data is backed up prior to making changes to the data. The backup file contains the backup data and identification information to identify the backup data. Such identification information is useful restoring the computer system in the future.

If there is not much change of the data, the data amount to be backed up will be relatively small. Accordingly, the storage space that will be occupied by the backup data can be reduced, and the required process time for restoration will also be short. The restoration process of the dynamic backup technique depends on the current state of the data in the hard disk. For this reason, every change to the data will be backed up by the backup/recovery software.

The conventional backup/recovery software even though has the backup/recovery capabilities to back up and/or recover data in the hard disk, the conventional backup/recovery software is ordinarily fail to protect hard disk data effectively owing to several operations performed by the users.

For example, the users may boot a computer system through a soft drive. Besides, the users may boot a multi operating system (multi-OS) computer from the operating system without a conventional backup/recovery software product stored therein. The presently available backup/recovery software is incapable of protecting the computer system in these events. Under such conditions, changes to the hard disk data would be out of protection of the software.

Since changes to the hard disk data is out of protection of the backup/recovery software, data kept in the backup points and data stored in the hard disk may not be identical.

Inconsistencies can occur if data is changed while the backup/recovery software is not monitoring the hard disk drive. Restoring from such backup point is not recommended. If the backup point is damaged or invalid for restoration, the users should not restore to those backup points.

### SUMMARY OF THE INVENTION

The present invention provides a backup/recovery system and method to resolve the foregoing problems faced by the conventional backup/recovery software. The present invention also has the advantage of providing a secret code function to the computer system.

An object of the present invention is to provide a security management system and method, wherein the file system is emulated. The file system uses a different file system structure to manage data on disks. The security management system protects the hard disk from being stolen and ensures that the hard disk data can not be recognized without authority.

Another object of the present invention is to provide a security management system and method, wherein the file system can not be directly recognized by an operating system (OS). The file system corresponds to specific operating system to recognize data.

A further object of the present invention is to provide a security management system and method, which can eliminate the leakage of confidential data, to achieve the highest reliability. The stored data is invisible to the unauthorized users, so as to prevent purposeful or involuntary monitoring the computer system, in order to substantially raise the reliability.

In accordance with an aspect of the present invention, the present invention provides a security protection technique that can securely protect data in a computer system. The improvement is remarkable for the backup/recovery system while the user will reboot the computer system from the operating system with a security management system.

To achieve these and other advantages and in accordance with the purpose of the invention, as embodied and broadly described herein, the invention provides a method for securely protecting the computer system and data stored therein.

In accordance with an aspect of the present invention, a security management system is installed in a computer system. The computer system has a file system, an operating system and a storage device. The security management system includes at least a converting module for converting a file system and storing the converted file system in a storage device and a controlling module for generating a control signal and enabling/disabling an operating system recognizing data stored in the storage device in accordance with the control signal. In this embodiment, any operating system other than said operating system is incapable of recognizing data stored in the storage device.

In the preferred embodiment of the invention, the controlling module includes a processor for processing the converted file system. The processor may be a key, a program or the like. The processed file system can be implemented and recognized by the operating system. The controlling module includes a protector for protecting security of the computer system. The control signal disables the operating system recognizing data stored in the storage device. A file structure of the file system, a BIOS parameter block, a cluster, a flag of the file system or sector count of boot sector may be modified.

In accordance with another aspect of the present invention, computer system architecture comprises a hardware resource, an operating system, a file system and a backup system. The hardware resource has at least one partition. The operating system is stored in the hardware resource, for controlling the hardware resource. The file system is used for managing files stored in the partition. The backup system accesses the files and implements the hardware resource through the operating system. In this embodiment, the backup system includes a changing module for changing the file system, a converting module for converting the changed file system, and a controlling module for read/write operation.

In the preferred embodiment of the invention, a file structure of the file system, a BIOS parameter block, a cluster, a flag of the file system or sector count of boot sector may be modified. The controlling module performs read/write operation at the time the operating system reads/writes a hard disk. The controlling module may include a filter program.

It is to be understood that both the foregoing general description and the following detailed description are exemplary, and are intended to provide further explanation of the invention as claimed.

### BRIEF DESCRIPTION OF THE DRAWINGS

The above-mentioned objects and other objects and features of this invention and manner of attaining them will become apparent, and the invention itself will be understood by reference to the following description of the preferred embodiments of the invention taken in conjunction with the accompanying drawings, which are given by way of illustration only, and thus are not limitative of the present invention, and wherein:

FIG. 1 is a schematic diagram of a security management system as an embodiment of the invention;

FIG. 2 is a schematic diagram of a computer system architecture as an embodiment of the invention.

### DESCRIPTION OF THE PREFERRED EMBODIMENT

Reference will now be made in detail to the present preferred embodiments of the invention, examples of which are illustrated in the accompanying drawings. Wherever possible, the same reference numbers are used in the drawings and the description to refer to the same or like parts.

The present invention contemplates a security management system to provide protection for the computer system by way of recognition operation of the operating system. According to the preferred embodiment of the present invention, a security management system is installed in a computer system. The computer system has a file system, an operating system and a storage device. The file system and the operating system are stored in the storage device. The operating system supports the file system. The security management system includes at least a converting module and a controlling module. A converting module is used for converting the file system and storing the converted file system in the storage device. A controlling module is coupled to the converting module, for generating a control signal and enabling/disabling the operating system recognizing data stored in the storage device in accordance with the control signal. Any operating system other than the operating system is incapable of recognizing data stored in the storage device.

The controlling module includes a processor for processing the converted file system. The processor may be a key, a program or the like. The processed file system can be implemented and recognized by the operating system. The controlling module includes a protector for protecting security of the computer system. The control signal disables the operating system recognizing data stored in the storage device. A file structure of the file system, a BIOS parameter block, a cluster, a flag of the file system or sector count of boot sector may be modified.

The system area and the data area contained in the modified partition are different from the original in size. The modified partition is not compatible with the original either. The specific operating system can recognize the original partition; however, the modified partition cannot be directly recognized. Moreover, n˜ operating system is capable of recognizing data stored in the modified partition. Only if the converted file system has been converted back to the original file system is the specific operating system capable of recognizing the modified partition.

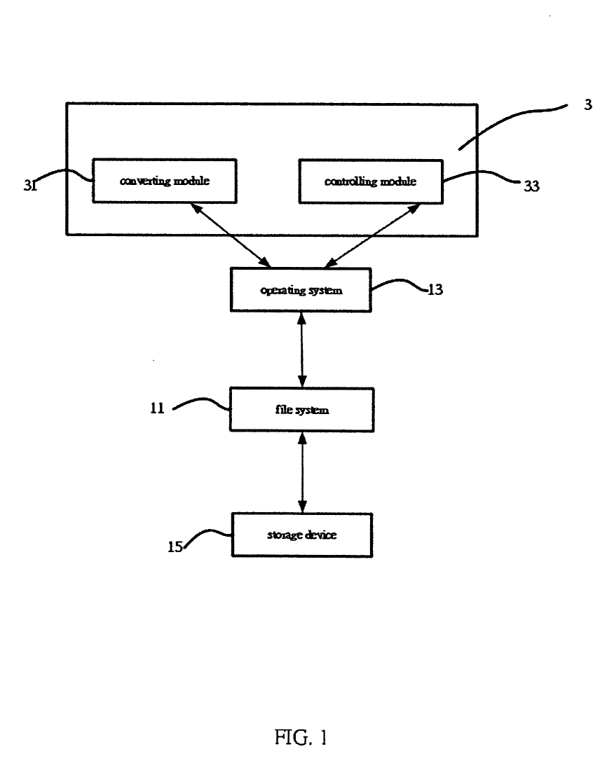

FIG. 1 is a schematic diagram of a security management system as an embodiment of the invention. The security management system 3 is installed in a computer system having a file system 11, an operating system 13 and a storage device 15. The security management system 3 includes a converting module 31 and a controlling module 33.

The file system 11 uses a file system structure to manage data on the storage device 15, such as a hard disk, of the computer system. The storage device 15 may have at least one partition. The file system structure stores information about files on the storage device 15. The data on the storage device 15 is generally divided into files, and the information stored in the file system structure generally includes the name and location of each file, in addition to other attributes of the files.

A file structure of the file system, a BIOS parameter block, sector count of boot sector, a cluster, a flag or BPB (Bios parameter block) of the file system 11 may be modified. Referring to FIG. 1, the converting module 31 is used for converting the file system 11 and storing the modified file system in the storage device 15.

The system area and the data area contained in the modified partition are different from the original in size. The modified partition is not compatible with the original either. The operating system 13 can recognize the original partition; however, the modified partition cannot be directly recognized.

A controlling module 33 is coupled to the converting module 31, for generating a control signal and enabling/disabling the operating system 13 recognizing data stored in the storage device 15 in accordance with the control signal.

The controlling module 33 includes a processor for processing the converted file system. The processor may be a key, a program or the like. The processed file system can be implemented and recognized by the operating system 13.

A file structure of the file system, a BIOS parameter block, sector count of boot sector, a cluster, a flag or BPB (bios parameter block) of the file system may be emulated, and the operating system 13 can work without writing back to the actual partition.

No operating system is capable of recognizing data stored in the modified partition. Only if the converted file system has been processed is the operating system 13 capable of recognizing the modified partition.

The controlling module 33 includes a protector for protecting security of the computer system. The data stored in the storage device 15 can be safely and confidentially maintained. The control signal disables the operating system 13 recognizing data stored in the storage device 15. Any operating system other than the operating system 13 in the computer system is incapable of recognizing data stored in the storage device 15.

According to the preferred embodiment of the present invention, computer system architecture comprises a hardware resource, an operating system, a file system and a backup system. The hardware resource has at least one partition. The operating system is stored in the hardware resource, for controlling the hardware resource. The file system is used for managing files stored in the partition. The backup system accesses the files and implements the hardware resource through the operating system. In this embodiment, the backup system includes a changing module for changing the file system, a converting module for converting the changed file system, and a controlling module for read/write operation.

A file structure of the file system, a BIOS parameter block, sector count of boot sector, a cluster, a flag or BPB (Bios parameter block) of the file system may be modified. The specific operating system can recognize the original partition; however, the modified partition cannot be directly recognized. Moreover, no operating system is capable of recognizing data stored in the modified partition.

The controlling module performs read/write operation at the time the operating system reads/writes a hard disk. The controlling module may include a filter program. The filter program can be a driver program for protecting the hard disk.

Only if the changed file system has been converted back to the original file system is the specific operating system capable of recognizing the modified partition.

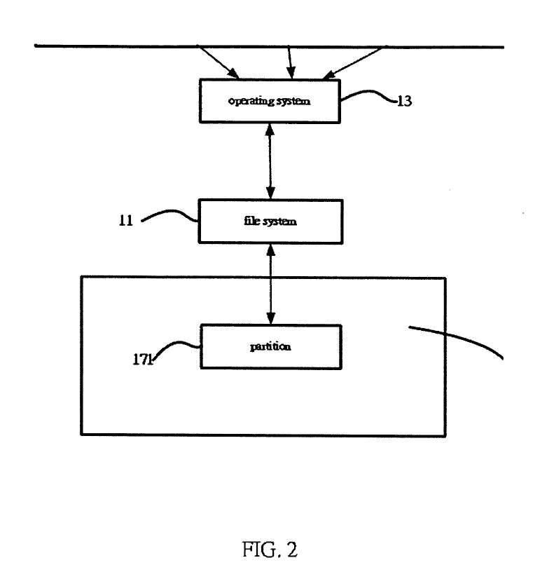

FIG. 2 is a schematic diagram of computer system architecture as an embodiment of the invention.

The computer system architecture comprises a hardware resource 17, an operating system 13, a file system 11 and a backup/recovery system 5. The hardware resource 17 can be a hard disk and has at least one partition 171. Files are stored in the partition 171. The operating system 13 is stored in the hardware resource 17, for controlling the hardware resource 17 and recognizing the partition 171.

The file system II is used for managing files stored in the partition 171. The file system II uses a file system structure to manage data on disks. A file system structure stores information about files on the disk. The backup system 5 accesses the files and implements the hardware resource 17 through the operating system 13. In this embodiment, the backup system 5 includes a changing module 51, a converting module 53, and a controlling module 55.

The changing module 51 changes the file system II and stores into the hardware resource 17. A file structure of the file system II, a BIOS parameter block, sector count of boot sector, a cluster, a flag or BPB (Bios parameter block) of the file system II may be modified.

The system area and the data area contained in the modified partition are different from the original in size. The modified partition is not compatible with the original either. The operating system 13 can recognize the original partition; however, the modified partition cannot be directly recognized.

If the file system II is changed, the operating system 13 will not be able to boot from that disk. As the operating system 13 is booted, it relies on the file system II being unchanged, in order to find and update files as needed. No operating system is capable of recognizing data stored in the modified partition.

The converting module 53 is used for converting the changed file system. The converting module 53 may be a key, a program, to convert into the identical file system. So the controlling module 55 may perform read/write operation at the time the operating system 13 reads/writes the hard disk. The controlling module 55 may be a filter program for protecting the hard disk.

The operating system 13 will not be able to boot from the disk which the file system II is changed. Only if the changed file system has been converted back to the original file system II is the operating system 13 capable of recognizing the modified partition.

A file structure of the file system, a BIOS parameter block, sector count of boot sector, a cluster, a flag or BPB (bios parameter block) of the file system may be emulated, and the operating system 13 can work without writing back to the actual partition.

The backup system 5 may provide a secret code function to the computer system. The data can be safely and confidentially maintained within the hardware resource 17 even though the hardware resource 17 has been stolen. Moreover, the confidentially data is still in secret no matter what has been done to the hardware resource 17.

The present invention prohibits startup operation from booting the floppy or other boot system rather than the system with the backup system of the present invention so that the users can be informed of the reboot operation. The whole protection can effectively solved the security problem of the computer system faced by the conventional backup/recovery software. The present invention also ensures the data won't be destroyed due to the computer system that can be booted by any boot system. Hence, the shortcoming that the computer system cannot be securely protected under backup/recovery software can be entirely avoided.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A security management system, which is installed in a computer system having a file system, an operating system and a storage device, said file system and said operating system being stored in said storage device, said operating system supporting said file system, said security management system comprising:
a converting module for converting said file system and storing said converted file system in said storage device; and
a controlling module for generating a control signal and enabling/disabling said operating system recognizing data stored in said storage device in accordance with said control signal, wherein any operating system other than said operating system is incapable of recognizing data stored in said storage device.

2. The security management system according to claim 1, wherein said controlling module includes a processor for processing said converted file system.

3. The security management system according to claim 2, wherein said processor includes a key.

4. The security management system according to claim 2, wherein said processor includes a program.

5. The security management system according to claim 2, wherein said converted file system can be implemented and recognized by said operating system.

6. The security management system according to claim 1, wherein said controlling module includes a protector for protecting security of said computer system.

7. The security management system according to claim 6, wherein said control signal disables said operating system recognizing data stored in said storage device.

8. The security management system according to claim 1, wherein a file structure of said file system is modified.

9. The security management system according to claim 8, wherein a BIOS parameter block is modified.

10. The security management system according to claim 8, wherein sector counts of boot sector is modified.

11. The security management system according to claim 8, wherein a cluster is modified.

12. The security management system according to claim 8, wherein a flag of said FAT file system is modified.

13. A computer system architecture comprising:
a hardware resource having at least one partition;
an operating system being stored in said hardware resource, for controlling said hardware resource;
a file system for managing files stored in said partition; and
a backup system accessing said files and implementing said hardware resource through said operating system; wherein said backup system includes a changing module for changing said file system, a converting module for converting said changed file system, and a controlling module for read/write operation.

14. The computer system architecture according to claim 13, wherein a file structure of said file system is modified.

15. The computer system architecture according to claim 14, wherein a BIOS parameter block is modified.

16. The computer system architecture according to claim 14, wherein sector counts of boot sector is modified.

17. The computer system architecture according to claim 14, wherein a cluster is modified.

18. The computer system architecture according to claim 14, wherein a flag of said FAT file system is modified.

19. The computer system architecture according to claim 13, wherein said controlling module performs read/write operation at the time said operating system reads/writes a hard disk.

20. The computer system architecture according to claim 13, wherein said controlling module includes a filter program.
